(19) United States
(12) Patent Application Publication
(10) Pub. No.: US 2014/0182864 A1
(43) Pub. Date: Jul. 3, 2014

(54) EMBER BLOCKING VENTILATION DEVICE

(71) Applicants: Bret L. de St. Jeor, Modesto, CA (US); David W. Reeves, Modesto, CA (US)

(72) Inventors: Bret L. de St. Jeor, Modesto, CA (US); David W. Reeves, Modesto, CA (US)

(21) Appl. No.: 14/143,458

(22) Filed: Dec. 30, 2013

Related U.S. Application Data
(60) Provisional application No. 61/746,948, filed on Dec. 28, 2012.

(51) Int. Cl. A62C 2/06

(52) U.S. Cl. CPC A62C 3/14
USPC 169/45; 169/56

(57) ABSTRACT

Exemplary embodiments of an ember blocking ventilation device are disclosed. The ventilation device may be a mountable device having a frame that can hold a layer of endothermic materials and bonded filters. The device can allow for normal ventilation of a building while preventing the entry of burning embers or flames into a building through ventilation shafts or open ventilation spaces.

### BACKGROUND

Wildfires are prevalent in certain portions of the world where there is a substantial amount of combustible vegetation and hot and dry weather conditions that make vegetation more susceptible to combustion. When wildfires break out, burning embers are created from the combustible vegetation. These embers are typically light weight and can be blown away and start other fires far away from the original wildfire. Often, as a result of wildfires, structures in the general area are subjected to “ember attacks.” Embers can enter a structure through ventilation systems or other structural openings and start potentially catastrophic fires in the structure.

Existing, unprotected ventilation systems are disadvantageous in environments subject to wildfires because leaving ventilation systems unprotected can allow burning embers to enter a building and start a potentially catastrophic fire. Other known ventilation systems with baffles or heat-reactive materials may not be wholly effective in preventing burning embers from entering a structure and causing a fire. Thus, an improved device for allowing ventilation of a building and preventing the intrusion of embers is desired.

### SUMMARY

An exemplary embodiment of a device for preventing the entry of burning embers into ventilation systems while still allowing for ventilation of a building may be described. The device may be configured to couple to the exterior opening of a ventilation system. The device may have a frame having a partially open first end and an open second end. A combination of filtration and heat-reactive materials may be inserted into the metal frame abutting the partially open first end. The device may have endothermic materials coupled to the exterior of the metal frame.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows an exemplary embodiment of an ember-proof ventilation device having a frame, a layer of perforated endothermic material, a filter layer, a mounting flange, and mounting clips on the frame.

FIG. 2 shows an exemplary embodiment of a frame for housing a layer of perforated endothermic material and filter having a flange, mounting holes, and mounting clips.

FIG. 3 shows an exemplary exploded view of a fire vent.

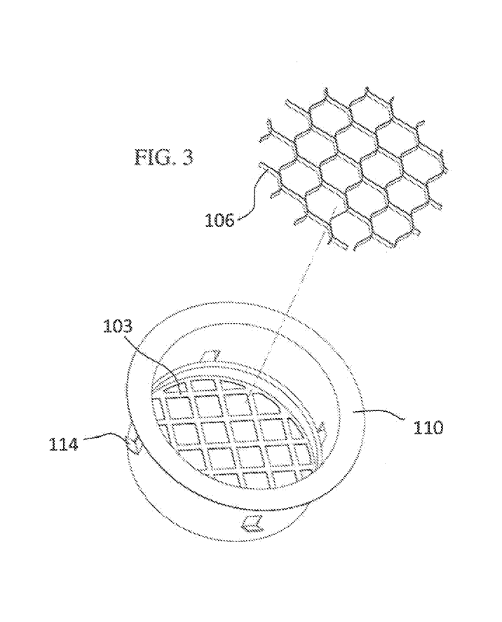

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

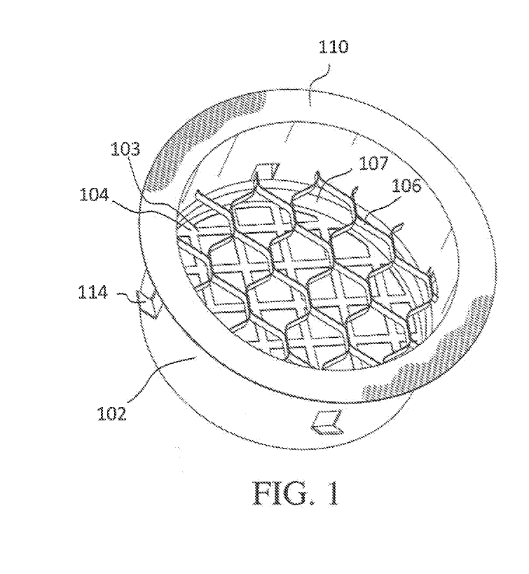

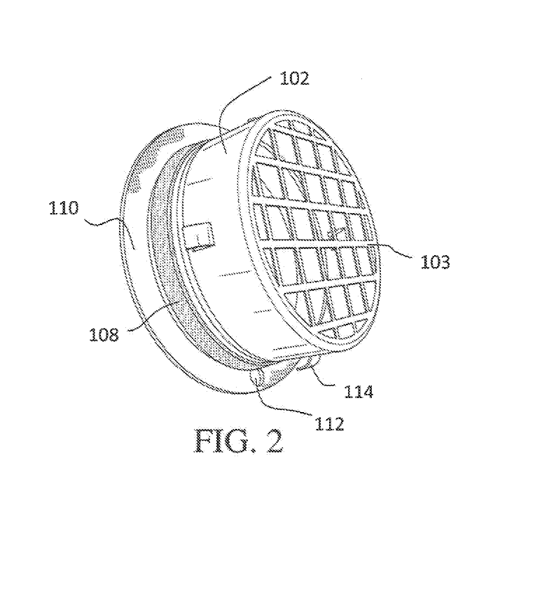

Generally referring to FIGS. 1-2, an ember-blocking ventilation device may be described. The ventilation device 100 may be a removable device generally having a cylindrical body that may house materials for blocking the entry of embers into a ventilation system. Frame 102 can be an elongated chamber and generally defines the size and structure of ventilation device 100. Frame 102 can be made from metal or any other desired fireproof material, including, but not limited to composites, molded fiberglass, or other appropriate materials. Frame 102 may have a first, partially open, end and a second, completely open, end. The first, partially open end may have a grate 103 or grate-like covering over the partially open end. The second, completely open end may have a flange 110 disposed around its perimeter. Frame 102 may further be configured to contain a layer or band of heat sensitive material, such as an endothermic or intumescent material 104, filter 106, and a perforated endothermic or intumescent pad. The perforated pad may further include any other materials, as desired, depending on application. The exterior of frame 102 may be coupled to endothermic or intumescent band 108. When coupled to a ventilation shaft or other open ventilation areas, ventilation device 100 may prevent the entry of flames or embers through both the interior and exterior of the device.

Referring now to FIG. 1, an exemplary embodiment of an ember blocking ventilation device may be shown. The partially open end of frame 102 may have a grid pattern or other similar structure that allows for normal ventilation while providing support for materials inserted into the frame. Frame 102 may have a perforated endothermic or intumescent band or layer 104 coupled to the partially open end of frame 102. Endothermic or intumescent layer 104 may be made from any desired material that swells in the presence of heat from a fire, for example endothermic or intumescent material made by GE®, 3M®, or manufacturers of similar materials. Such swelling may act to seal ventilation device 100. The swelling and sealing of layer 104 may thus seal ventilation device 100 from any outside embers or heat sources. Filter 106 may be coupled to and held within frame 102. In some embodiments, filter 106 may also be coupled to endothermic or intumescent layer 104. Filter 106 may be made from bonded aluminum or any other appropriate filtration material that is designed specifically for ventilation and is fire rated. In some further exemplary embodiments, filter 106 may be an aluminum mesh or an aluminum mesh material may be otherwise disposed in an interior portion of ventilation device 100 to provide further blocking or filtering capabilities. The mesh material may be, for example, an ember resistant material and may have any desired width or volume, for example to fill a desired portion of device 100. In some embodiments, a perforated pad may also be contained within frame 102 and may comprise endothermic or intumescent material, subject to application. Further, an indented or depressed ring 107 or any other known formation in an interior portion of device 100 may act to secure or retain filter 106 or any other component inside device 100.

Still referring to exemplary FIG. 1, in some further embodiments, an endothermic or intumescent band 108 may be placed around frame 102. Band 108 may be disposed, for example, around an exterior portion of frame 102 proximate the partially open end. Band 108 may be formed in a similar manner or using similar to materials to that of layer 104. Thus, as heat is applied or an ambient temperature around device 100 rises, hand 108 may act to seal device 100 with respect to the surface through which device 100 is mounted, such as a wall of a building or home. The placement and material of band 108 may vary depending on the application. In some exemplary embodiments, device 100 may be mounted to an eve structure of a roofline, which may allow it to be in fluid communication with an internal or attic space. In other exemplary embodiments, device 100 may be mounted in any of a variety of sheet metal applications, subfloor applications, basement applications or any other application location desired.

Referring now to FIG. 2, an exemplary embodiment of frame 102 may be shown. Frame 102 may have a partially open first end and an open second end. A flange 110 may be coupled to the open second end of frame 102. Flange 110 may have a plurality of mounting holes 112. Mounting holes 112 may be configured to accept screws, nails, or any other appropriate construction fastener device. A plurality of fasteners may be coupled to the exterior of frame 102. Endothermic band 108 may be coupled to the exterior of frame 102 and may be made from any appropriate endothermic material that expands in size in the presence of extreme heat.

In some embodiments, ventilation device 100 may be coupled to a ventilation shaft or open ventilation system using screws, nails, or other appropriate fastener, as known in the art. A screw, nail, or other appropriate fastener may be positioned in each mounting hole 112 and attach the ventilation device 100 to a ventilation shaft or open ventilation system by securing said device to the surface surrounding a ventilation shaft opening (e.g. wall board, roofing, etc.). In other embodiments, flange 110 may omit mounting holes 112. The side of flange 110 facing the partially open first end of frame 102 may be coated with a heat resistant adhesive. The heat resistant adhesive may be used to attach ventilation device to the surface surrounding a ventilation shaft opening.

The embodiments described herein allow for the shielding of ventilation shafts from burning embers while allowing normal ventilation of a building. The filtration layer protects against intrusion of burning embers. At temperatures below the failure temperature of the filtration layers, the endothermic material both on the inside and outside of frame 102 expands when exposed to external heat sources in excess of about 300 degrees Fahrenheit, effectively sealing any opening in the ventilation device 100.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A fire vent, comprising:
a cylindrical body having an open end and a partially open end;
a grate disposed over the partially open end;
a heat sensitive band disposed around an exterior the cylindrical body;
a heat sensitive band or layer disposed around an interior portion of the cylindrical body; and
a mesh material substantially filling the interior portion of the cylindrical body.

2. The fire vent of claim 1, wherein the heat sensitive band disposed around the exterior the cylindrical body is formed of an endothermic material.

3. The fire vent of claim 1, wherein the heat sensitive band disposed around the exterior the cylindrical body is formed of an intumescent material.

4. The fire vent of claim 1, wherein the heat sensitive band disposed around the interior the cylindrical body is formed of an endothermic material.

5. The fire vent of claim 1, wherein the heat sensitive band disposed around the interior the cylindrical body is formed of an endothermic material.

6. The fire vent of claim 1, wherein the mesh material is aluminum.

7. The fire vent of claim 1, wherein the mesh material is an ember resistant material.

8. The fire vent of claim 1, further comprising a plurality of fasteners on the exterior of the cylindrical body.

9. The fire vent of claim 1, further comprising an indented layer on the interior portion of the cylindrical body that secures the mesh inside the cylindrical body.

10. The fire vent of claim 1, further comprising at least one mounting hole disposed on a flange proximate the open end of the cylindrical body.

11. A method of preventing the spread of fire, comprising:
forming a cylindrical body with a grated end and an open end;
mounting the cylindrical body in a desired ventilation location;
sealing an exterior portion of the cylindrical body to a surrounding structure with a band of heat sensitive material;
disposing a mesh material proximate the grated end of the cylindrical body; and
sealing the mesh on the interior of the cylindrical body with a heat sensitive material.
